(19) United States
(12) Patent Application Publication
(10) Pub. No.: US 2020/0088700 A1
(43) Pub. Date: Mar. 19, 2020

(54) CHROMATOGRAM DATA PROCESSING DEVICE

(71) Applicant: SHIMADZU CORPORATION, Kyoto-shi, Kyoto (JP)

(72) Inventor: Shinichi YAMAGUCHI, Kyoto-shi (JP)

(73) Assignee: SHIMADZU CORPORATION, Kyoto-shi, Kyoto (JP)

(21) Appl. No.: 16/346,152

(22) PCT Filed: Jan. 23, 2017
(86) PCT No.: PCT/JP2017/002132

§ 371 Date: Apr. 30, 2019

(51) Int. Cl. G01N 30/86; G01N 30/72

(52) U.S. Cl. CPC G01N 30/8631; G01N 30/7233

(57) ABSTRACT

A peak detection unit collects peak information by executing peak detection on data obtained by performing LC/MS analysis on a plurality of specimens. A same-component candidate extraction unit extracts peaks between which retention time difference and m/z value difference are equal to or smaller than an allowable value among two or more peaks for specimens different from each other, and a spectrum similarity determination unit calculates similarity between mass spectra corresponding to the two or more peaks, respectively. When the similarity is equal to or larger than a predetermined value, it is determined that the two or more peaks are attributable to the same component, and a retention-time and m/z-value correction unit performs correction to eliminate any difference between the retention times or m/z values of peaks. A data array table production unit produces a data array table based on peak information after the retention time and m/z value correction.

### TECHNICAL FIELD

The present invention relates to a chromatogram data processing device configured to process data collected by a chromatograph including a mass spectrometer, an absorption spectroscopic detector, or the like as a detector, and particularly relates to a chromatogram data processing device configured to process data obtained for a plurality of specimens to perform, for example, statistical analysis based on the data.

### BACKGROUND ΔRT

In a liquid chromatograph (LC) and a gas chromatograph (GC) each including a mass spectrometer as a detector, in other words, in a liquid chromatograph mass spectrometer (LC-MS) and a gas chromatograph mass spectrometer (GC-MS), three-dimensional chromatogram data having three dimensions of the retention time, the mass-to-charge ratio, and the signal intensity is obtained by repeating mass spectrometry in a predetermined mass-to-charge ratio range at the mass spectrometer. In an LC including a photodiode array (PDA) detector or an ultraviolet-visible absorption spectroscopic detector as a detector, three-dimensional chromatogram data having three dimensions of the retention time, the wavelength, and the signal intensity (absorbance) is obtained by repeatedly acquiring an absorption spectrum in a predetermined wavelength range at the detector.

Recently, in various fields of medicine, food, environment, and the like, analyses using a multivariate analysis method have been widely performed on a large amount of data obtained by analyzing a large number of specimens by using a chromatograph device as described above. In the multivariate analysis, a commercially available statistical analysis calculation software such as SIMCA-P produced by Umetrics is often used. For example, when three-dimensional chromatogram data collected for a large number of specimens by using an LC-MS is to be processed by such a general-purpose software as above, the data needs to be appropriately arranged in a predetermined format before input to the software. “Profiling Solution” disclosed in Non Patent Literature 1 is known as a software product for such preparation data processing. In “Profiling Solution”, peak picking is performed on three-dimensional chromatogram data obtained for each of a plurality of specimens, and the retention time, mass-to-charge ratio, and signal intensity of each detected peak are arranged in a table format for an output.

For example, in chromatogram data obtained by the LC-MS, difference may occur in the elution time of the same component contained in different specimens due to variance or changes in a LC separation condition (such as linear speed of mobile phase). In the software disclosed in Non Patent Literature 1 and the device disclosed in Patent Literature 1, such difference in the elution time is automatically corrected by a retention time alignment function. For example, in the device disclosed in Patent Literature 1, peaks having elution times close to each other are determined to be attributable to the same component based on similarity between the shapes of the peaks on respective chromatograms produced on different mass-to-charge ratios, that is, extracted ion chromatograms. When the peaks are determined to be attributable to the same component, information on the retention time is adjusted to align the retention time.

However, for example, when the mass accuracy of the mass spectrometer is not adequate (for example, when the mass accuracy includes an error of one Da or so) or when peaks having the same mass-to-charge ratio appear close to each other in the time direction on the chromatogram, the retention time alignment as described above is not appropriately performed in some cases. As a result, in a data list in a produced table format, signal intensity data corresponding to ions of the same component, and should have the same mass-to-charge ratio, may be disposed on different rows, not on the same row. On the contrary, signal intensity data corresponding to ions of different components, and should have different mass-to-charge ratios, may be disposed on the same row. When such an inappropriate data list is fed in a table format to multivariate analysis, the analysis result is naturally incorrect.

### CITATION LIST

### Patent Literature

Patent Literature 1: WO 2013/001618

### Non Patent Literature

Non Patent Literature 1: “LCMS-IT-TOF Liquid Chromatograph Mass Spectrometer LCMS-IT-TOF Metabolomics Software Profiling Solution”, Shimadzu Corporation, [online], [searched on Jan. 18, 2017], the Internet <URL: http://www.an.shimadzu.co.jp/lcms/it-tof6.htm>

### SUMMARY OF INVENTION

### Technical Problem

The present invention is intended to solve the above-described problem and provides a chromatogram data processing device that can improve the accuracy of a table data list produced by appropriately arranging peak information obtained by performing peak picking or the like on data of a plurality of specimens obtained by a chromatograph device, and accordingly, can improve the accuracy of analysis such as statistical analysis based on the data list.

### Solution to Problem

The present invention for solving the above-described problem is a chromatogram data processing device configured to process data of a plurality of specimens collected by using an analysis device including a chromatograph configured to separate a plurality of components contained in a specimen in a time direction and a detection unit configured to acquire signal intensities in a second dimension different from the time direction for the specimen after being separated by the chromatograph. The chromatogram data processing device includes:

a) a peak detection unit configured to execute peak detection on a plurality of sets of chromatogram data of the plurality of specimens and to collect peak information including a retention time for each detected peak;

b) a same component determination unit configured to determine, when difference between at least retention times of two or more peaks derived from specimens different from each other is zero or within a predetermined range, whether the two or more peaks are attributable to a same component based on similarity between signal intensity waveforms along the second dimension or between signal intensity values at a value of the second dimension, and correct the retention times and/or values of the second dimension of one or more of the two or more peaks as necessary; and

c) a data list production unit configured to arrange, based on data corrected by the same component determination unit, the retention time and the second dimension in one of a column direction and a row direction, and information for identifying a plurality of specimens in the other of the column direction and the row direction, and produce a data list in a table format including, as a matrix element, a signal intensity value at a retention time and a second dimension value of a specimen.

The above-described “chromatograph” is typically an LC or GC. When the above-described “detection unit” is a mass spectrometer, the above-described “second dimension” a mass-to-charge ratio. When the above-described “detection unit” is a PDA detector, an ultraviolet-visible absorption spectroscopic detector, or a spectral fluorescence detector, the above-described “second dimension” is wavelength. When the above-described “detection unit” is a mass spectrometer, the mass spectrometer includes a mass spectrometer capable of performing MS/MS analysis or MSⁿ analysis like a tandem quadrupole mass spectrometer, and in this case, a mass spectrum includes an MS:MS spectrum or an MSⁿ spectrum. The above-described retention time may be a retention index.

In the chromatogram data processing device according to the present invention, the peak detection unit executes peak detection on a plurality of sets of chromatogram data for a plurality of specimens at least in the time direction. Then, peak information such as the retention time and the signal intensity value is collected for each detected peak. An algorithm of the peak detection may be one of those conventionally used. The same component determination unit compares at least retention times (or retention indexes corresponding to retention times or the like) of two or more peaks derived from specimens different from each other, and extracts two or more peaks for which the difference between the retention times is zero or within a predetermined range. Such two or more peaks may be extracted based on, in addition to the difference between retention times, by determining whether the difference between values of the above-described second dimension is zero or within a predetermined range.

The same component determination unit determines whether two or more peaks extracted as described above are attributable to the same component based on the similarity between signal intensity waveforms along the direction of the second dimension or the similarity between signal intensity values at a value of the second dimension. For example, when the above-described “detection unit” is a mass spectrometer and the above-described “second dimension” is a mass-to-charge ratio, the signal intensity waveforms along the direction of the second dimension are mass spectrum waveforms, and thus whether the two or more peaks are attributable to the same component may be determined based on similarity between the spectrum patterns of two or more mass spectra corresponding to the two or more peaks, respectively. Then, when the retention times or the values of the above-described second dimension (for example, mass-to-charge ratio values) of two or more peaks determined to be attributable to the same component are different from each other, correction is performed to equalize the retention times or the values.

The retention times or second dimension values of peaks attributable to the same component in different specimens become the same through the above-described processing, and thus the data list production unit produces a data list in a table format based on data corrected in this manner. As a result, information on the same component in different specimens is not disposed on different rows or columns in the data list, and a highly accurate data list can be obtained.

In an aspect of the chromatogram data processing device according to the present invention, the same component determination unit may calculate similarity between signal intensity waveforms in the direction of the second dimension at respective retention times of peak tops of two or more peaks derived from specimens different from each other, and determine whether the two or more peaks are attributable to the same component based on the similarity.

This aspect of invention is effective for a case in which a signal intensity that is continuous in effect in the direction of a second dimension different from time can be obtained in each retention time, such as the above-described case of mass spectrum or absorption spectrum.

For example, various spatial distances such as a Pearson's moment correlation coefficient or a Euclidean distance can be used as the measure of similarities.

In another aspect of the chromatogram data processing device according to the present invention, the same component determination unit may calculate difference or distance between signal intensity values at one or a plurality of second dimension values at respective retention times of peak tops of two or more peaks attributable to specimens different from each other, and determine whether the two or more peaks are attributable to the same component based on the difference or the distance.

This aspect of the invention is effective for a case in which a signal intensity that is continuous, or effectively continuous, in the direction of a second dimension different from time can be obtained in each retention time as described above, as well as for a case in which signal intensity is obtained at only one or a plurality of (typically, small number of) values in the second dimensions.

### Advantageous Effects of Invention

With the chromatogram data processing device according to the present invention, when the retention time, the mass-to-charge ratio value, or the like is shifted between peaks derived from the same component for data on a plurality of specimens obtained by an analysis device such as an LC using an LC-MS, a GC-MS, or a PDA detector as a detector, the shift can be accurately corrected to produce a highly accurate data list. In particular, when two or more peaks derived from different components which have close mass-to-charge ratio values or close wavelength values appear at retention times close to each other, it can be accurately recognized that the components are different from each other by determining component identity based on similarity of the entire mass spectrum or absorption spectrum. In this manner, an accurate data list as compared to conventional cases is provided to statistical analysis, thereby improving the accuracy of the statistical analysis.

### BRIEF DESCRIPTION OF DRAWINGS

FIG. 1 is a schematic configuration diagram of an exemplary LC-MS using a chromatogram data processing device according to the present invention.

FIG. 2 is a flowchart illustrating the procedure of characteristic data processing performed by a data processing unit of the LC-MS of the present example.

FIG. 3 is a conceptual diagram for description of data processing at the LC-MS of the present example.

FIG. 4 is a diagram illustrating an exemplary data array table.

### DESCRIPTION OF EMBODIMENTS

The following describes an LC-MS as an exemplary analysis device including a chromatogram data processing device according to the present invention with the accompanying drawings.

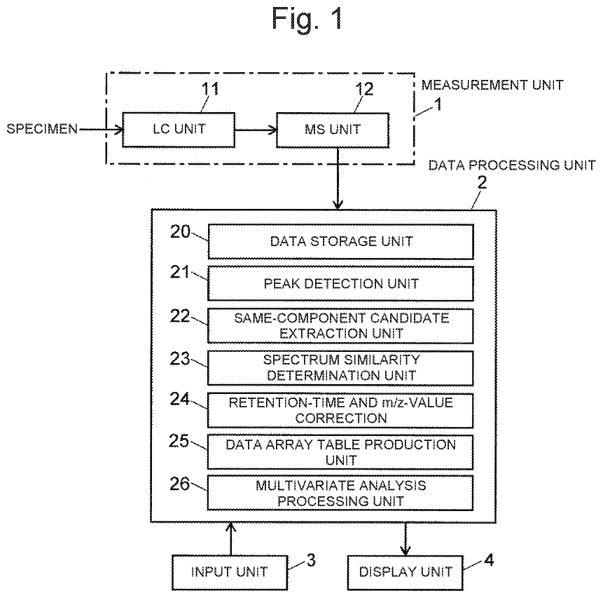

FIG. 1 is a schematic configuration diagram of an LC-MS of the present example.

The LC-MS of the present example includes a measurement unit 1 configured to execute measurement on a specimen, a data processing unit 2, and an input unit 3 and a display unit 4 as user interfaces.

The measurement unit 1 includes a liquid chromatograph unit (LC unit) 11 and a mass spectrometer (MS unit) 12. Although not illustrated, the LC unit 11 includes a pump configured to supply a mobile phase at a constant flow speed, an injector configured to inject a specimen into the supplied mobile phase, and a column configured to separate various components contained in the specimen in the time direction. The MS unit 12 includes an ion source configured to ionize components of elution liquid eluted from a column exit of the LC unit 11 upstream of the MS unit 12, a quadrupole mass filter configured to separate generated ions in accordance with the mass-to-charge ratio, a mass separator such as a time-of-flight mass separator, and a detector configured to detect the separated ions.

The data processing unit 2 includes, as functional blocks, a data storage unit 20, a peak detection unit 21, a same-component candidate extraction unit 22, a spectrum similarity determination unit 23, a retention-time and m/z-value correction unit 24, a data array table production unit 25, and a multivariate analysis processing unit 26. The data storage unit 20 stores, for each specimen, a data file in which data of a signal intensity value including the two parameters of the retention time and the mass-to-charge ratio, in other words, three-dimensional chromatogram data is recorded.

The entity of the data processing unit 2 is a personal computer. The function of each component described above may be achieved when dedicated data processing software installed on the personal computer is executed by the computer.

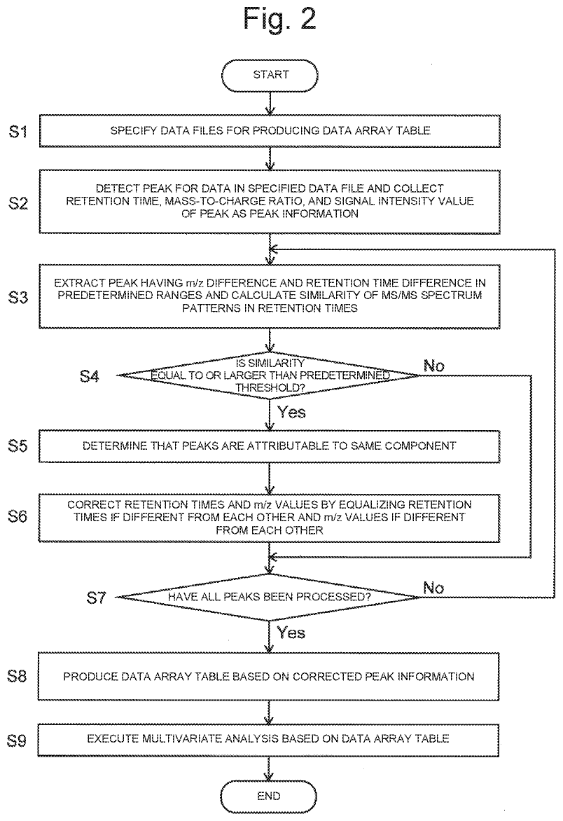

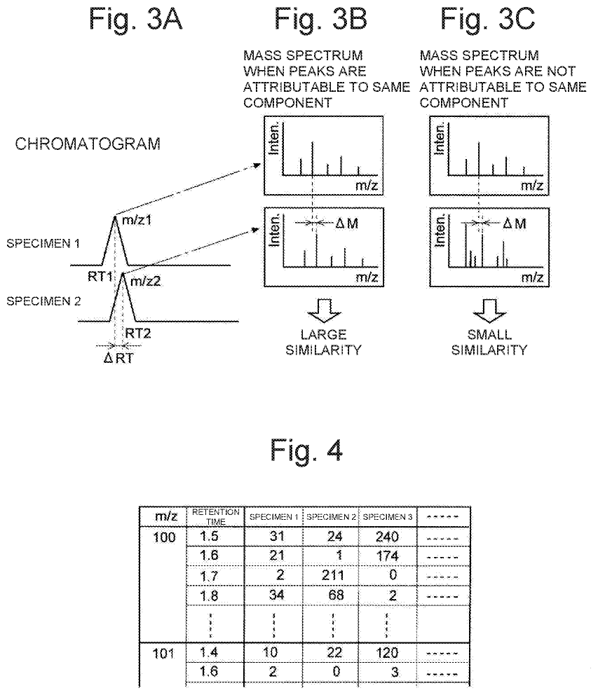

FIG. 2 is a flowchart illustrating the procedure of characteristic data processing performed by the data processing unit 2 of the LC-MS of the present example, FIG. 3 is a conceptual diagram for description of the data processing, and FIG. 4 is a diagram illustrating an exemplary data array table.

The following describes characteristic data processing at the LC-MS of the present example with reference to these drawings. This data processing performs multivariate analysis of determining difference and similarity between a plurality of specimens based on data files for the specimens, which are stored in the data storage unit 20 in advance.

An operator (user) specifies, through the input unit 3, a plurality of data files to be subjected to multivariate analysis (step S1). When the processing is started, the peak detection unit 21 reads the specified data files from the data storage unit 20. Then, peak picking is performed in accordance with a predetermined reference on three-dimensional chromatogram data stored in each data file, and the retention time, the mass-to-charge ratio, and the signal intensity value at the peak top of a peak are collected as peak information (step S2). Typically, a large number of peaks are detected from data in one data file corresponding to one specimen.

The same-component candidate extraction unit 22 extracts, from two or more peaks extracted from data files different from each other, peaks between which the retention time difference is equal to or smaller than a predetermined allowable value and the mass-to-charge ratio difference is equal to or smaller than a predetermined allowable value. The allowable values are preferably determined as appropriate in advance. The retention time allowable value may be determined with taken into account, for example, variance and variation in the flow speed of the mobile phase at the LC unit 11. The mass-to-charge ratio allowable value may be determined with device performance such as the mass accuracy of the MS unit 12 mainly taken into account. As described above, a pair of peaks extracted from data files different from each other, respectively, are candidates for peaks attributable to a same component.

Then, the spectrum similarity determination unit 23 produces mass spectra at a plurality of peaks included in one pair of peaks that are extracted as described above based on data in the data files, in other words, that are candidates for peaks attributable to the same component in the retention time. Then, spectrum pattern similarity between the mass spectra is calculated in accordance with a predetermined algorithm (step S3). When the plurality of peaks are peaks attributable to the same component, high similarity should be obtained between the spectrum patterns of the mass spectra corresponding to the plurality of respective peaks. Thus, it is determined whether the calculated similarity is equal to or larger than a predetermined threshold (step S4). When the similarity is equal to or larger than the threshold, it is determined that the plurality of peaks are peaks attributable to the same component (step S5).

As illustrated in FIG. 3A, a difference ΔRT between a retention time RTI of a peak for Specimen 1 and a retention time RT2 of a peak for Specimen 2 is equal to or smaller than a predetermined allowable value, and a difference ΔM between mass-to-charge ratios m/z1 and m/z2 is equal to or smaller than a predetermined allowable value. In this case, these peaks are extracted as candidates for peaks attributable to the same component. The similarity is high when mass spectra in the retention times RT1 and RT2 of the respective peaks are produced and the spectrum patterns of the two mass spectra are similar to each other as a whole as illustrated in FIG. 3B. The similarity is low when the spectrum patterns of the two mass spectra are not similar to each other as a whole as illustrated in FIG. 3C. In the case of FIG. 3B, it is determined that the two peaks are highly likely to be attributable to the same component. In the case of FIG. 3C, peaks incidentally exist at m/z1 and m/z2 where the mass-to-charge ratio difference ΔM is small on the mass spectra, but the other peaks do not substantially match with each other, and thus it is determined that the two peaks are highly likely to be not attributable to the same component.

When it is determined that a plurality of peaks are peaks attributable to the same component, any difference between the plurality of peaks in the retention time needs to be eliminated. Thus, the retention-time and m/z-value correction unit 24 equalizes the retention times by using one or both of the retention times. For example, the average of a plurality of retention times may be calculated, and the retention times may be equalized to the average. In addition, any difference between the plurality of peaks in the mass-to-charge ratio needs to be eliminated, and thus the retention-time and m/z-value correction unit 24 equalizes the mass-to-charge ratios by using one or both of the mass-to-charge ratios as in the case of the retention times (step S6).

Then, it is determined whether the processing at steps S3 to S6 has been executed for all peaks extracted based on the retention time and the mass-to-charge ratio as candidates for peaks attributable to the same component (step S7). The process returns to steps S7 to S3 when any peak is unprocessed. Accordingly, through repetition of the processing at steps S3 to S7, whether peaks are attributable to the same component is determined for all peaks extracted based on the retention time and the mass-to-charge ratio, and the processing of equalizing retention times and mass-to-charge ratios is performed for a plurality of peaks determined to be attributable to the same component.

When the determination is positive at step S7, the data array table production unit 25 arranges, based on peak information after the retention times and the mass-to-charge ratios are corrected, the retention times and the mass-to-charge ratios in the longitudinal direction and specimen identification information (for example, specimen numbers and specimen names) in the lateral direction as illustrated in FIG. 4, thereby producing a data array table or a matrix including a signal intensity value an element of each column (step S8). As described above, since the retention times and mass-to-charge ratios of peaks attributable to the same component are same for different specimens, the signal intensity values of peaks attributable to the same component are disposed on the same row. The multivariate analysis processing unit 26 reads the data array table produced in this manner, and executes predetermined multivariate analysis processing based on the table (step S9).

As described above, in the LC-MS of the present example, when retention time difference and mass-to-charge ratio difference of the same component are present in data obtained for different specimens, the differences can be appropriately corrected and can be handled as identical peaks. Accordingly, the accuracy of a result of the multivariate analysis based on the data array table is improved.

Various similarities can be used as the similarity between a plurality of mass spectra at step S3, but, for example, a Pearson's moment correlation coefficient can be used. As is well known, the Pearson's moment correlation coefficient is same as the cosine (cos) of two vectors. Alternatively, for example. Euclidean distance, Mahalanobis distance, Minkowski distance. Chebyshev distance, or Manhattan distance can also be used as similarity.

It may be determined whether peaks are attributable to the same component by using, in place of the similarity between the spectrum patterns of mass spectra, the similarity of a signal intensity value at a particular mass-to-charge ratio or a ratio of signal intensity values at a plurality of mass-to-charge ratios, in other words, difference or distance.

As it is clear from the above description, when the spectrum patterns of mass spectra are too simple, it is difficult to determine whether peaks are attributable to the same component. Thus, for example, a mass spectrum in which only protonated (or proton-eliminated) ions are observed is not much suitable for the determination of whether peaks are attributable to the same component, and a mass spectrum on which a compound structure is reflected, such as a mass spectrum using fragments by an electron ionization (EI) method or an ISD spectrum using in-source dissociation (ISD), is more suitable. For the same reason, an MS/MS (MSⁿ) spectrum obtained by MS/MS analysis or MSⁿ analysis is suitable for the determination of peaks attributable to the same component.

The chromatogram data processing device according to the present invention is also applicable to processing of data obtained by other various chromatograph devices as well as an LC-MS and a GC-MS. Specifically, the chromatogram data processing device is also applicable to processing of data obtained by an LC including a PDA detector, an ultraviolet-visible absorption spectroscopic detector, a spectral fluorescence detector, a differential refractive index detector, an electric conductivity detector, or the like as a detector, or by a GC including a thermal conductivity detector, an electron capture detector, a flame photometric detector, a hydrogen flame ionization detector, or the like as a detector.

The above-described embodiment is merely an example of the present invention, and it is clear that deformation, modification, addition, and the like made as appropriate within the scope of the gist of the present invention are included in the claims of the present application at points other than the above-described points.

### REFERENCE SIGNS LIST

1 . . . Measurement unit
11 . . . Liquid chromatograph unit (LC unit)
12 . . . Mass spectrometer (MS unit)
2 . . . Data processing unit
20 . . . Data storage unit
21 . . . Peak detection unit
22 . . . Same-component candidate extraction unit
23 . . . Spectrum similarity determination unit
24 . . . Retention-time and m/z-value correction unit
25 . . . Data array table production unit
26 . . . Multivariate analysis processing unit
3 . . . Input unit
4 . . . Display unit

1. A chromatogram data processing device configured to process data of a plurality of specimens collected by using an analysis device including a chromatograph configured to separate a plurality of components contained in a specimen in a time direction and a detection unit configured to acquire signal intensities in a second dimension different from the time direction for the specimen after being separated by the chromatograph, the chromatogram data processing device comprising:
a) a peak detection unit configured to execute peak detection on a plurality of sets of chromatogram data of the plurality of specimens and to collect peak information including a retention time for each detected peak;
b) a same component determination unit configured to determine, when difference between at least retention times of two or more peaks derived from specimens different from each other is zero or within a predetermined range, whether the peaks are attributable to a same component based on similarity between signal intensity waveforms along the second dimension or between signal intensity values at a value of the second dimension, and correct the retention times and/or values of the second dimension of one or more of the peaks as necessary; and
c) a data list production unit configured to arrange, based on data corrected by the same component determination unit, the retention time and the second dimension in one of a column direction and a row direction, and information for identifying a plurality of specimens in the other of the column direction and the row direction, and produce a data list in a table format including, as a matrix element, a signal intensity value at a retention time and a second dimension value of a specimen.

2. The chromatogram data processing device according to claim 1, wherein the same component determination unit calculates similarity between signal intensity waveforms in the direction of the second dimension in retention times of peak tops of two or more peaks derived from specimens different from each other, and determines whether the peaks are attributable to the same component based on the similarity.

3. (canceled)

4. The chromatogram data processing device according to claim 1, wherein the detection unit is a mass spectrometer, and the same component determination unit determines whether the peaks are attributable to the same component based on similarity between mass spectrum waveforms.

5. The chromatogram data processing device according to claim 1, wherein the detection unit is a photodiode array detector or an ultraviolet-visible absorption spectroscopic detector, and the same component determination unit determines whether the peaks are attributable to the same component based on similarity between absorption spectrum waveforms.

6. The chromatogram data processing device according to claim 1, wherein the similarity is similarity between spectrum patterns along the second dimension.

7. The chromatogram data processing device according to claim 1, wherein the similarity is similarity of a ratio of signal intensity values at a plurality of second dimension values along the second dimension.
